(19) United States
(12) Patent Application Publication
(10) Pub. No.: US 2025/0277498 A1
(43) Pub. Date: Sep. 4, 2025

(54) MAGNETIC ATTACHMENT SYSTEM AND METHOD OF USE THEREOF

(71) Applicant: B Bond Beyond Technology Ltd, Dubai (AE)

(72) Inventors: Dechawathr DULSAPSOPONT, Bangkok (TH); Surachai THONGKAEW, Lam Luk Ka, Pathum Thani (TH)

(73) Assignee: B Bond Beyond Technology Ltd, Dubai (AE)

(21) Appl. No.: 19/118,035

(22) PCT Filed: Jun. 24, 2022
(86) PCT No.: PCT/TH2022/000025

§ 371 Date: Apr. 3, 2025

(51) Int. Cl. F16B 1/00; G01D 5/14; H01F 7/20

(52) U.S. Cl. CPC F16B 1/00; G01D 5/142; H01F 7/20; F16B 2200/83

(57) ABSTRACT

The present invention develops a magnetic attachment system (100) comprising a permanent electromagnet (200), a sensing unit (300), and a processor for processing the attachment of the object thereon. The processor is configured to perform a method comprising:
i) partially reducing a magnetic field from an initial magnetic field of the permanent electromagnet (200) by applying electrical current thereto;
ii) detecting a pre-stage magnetic field via a magnetic detecting unit (304) and a pre-stage compression force via a compression detecting unit (306), when the user temporarily attaches the object to the permanent electromagnet (200);
iii) terminating applying the electrical current to fully attach the object after receiving to the user's instruction;
wherein step i) the electrical current will be applied in order to reduce the magnetic field of the permanent electromagnet (200) to be able to temporarily attach at least 70% of weight of the object;
wherein step ii) if the pre-stage compression force is not within a predetermined value of the pre-stage compression force, the processor will send a notification to the user.

In another aspect of the invention, the present invention relates to the method for attaching and sensing the object using the magnetic attachment system (100).

### FIELD OF INVENTION

The present invention relates to a magnetic attachment system and method of use thereof, where the magnetic attachment system includes a permanent electromagnet, a sensing unit, and a processor for processing the attachment of an object thereon.

### BACKGROUND OF INVENTION

Walls of any houses or buildings are usually made of brick and/or concrete. The walls can also be decorated with various objects such as tile, wood, hanging cabinets or paintings for interior design purposes. Installing and/or dismantling such objects on the wall requires expert technicians to conduct such activities, which consumes a lot of time and costs. Sometimes, the installation of an object on the wall may be subject to human error, by installation in the wrong position which is different from the design and may be difficult to resolve. Moreover, when a householder needs to renovate their house, the walls sometimes need to be demolished and cannot be recycled and reused. Dust from demolition of the walls is also considered pollution waste.

Nowadays, walls are also integrated with objects with specific functions in addition to the decorative function. For example sensors, touch screen displays, speakers, and/or internet of things (IoT) devices are installed on the wall to provide specific function to the users. Those objects may be installed onto the walls by attaching with screws and wiring to a power supply. Such conventional installation causes inconvenience to the householder because there is a need to drill the wall for installation, creating an unattractive interior mark on the wall, which cannot be concealed. If the householder wants to remove the devices, it is necessary to fill and re-paint holes. Also, with installation of heavy objects there is a need to determine the type of wall and object's weight before choosing the proper hanging technique so that the objects installed stay secure.

Therefore, there is a need to develop a panel system for replacing traditional walls, floors or ceilings to solve the problem of attaching objects without the need of a skilled technician and the object can also be disassembled, reinstalled and reused without requiring skills, using any hand tools, and safety concerns.

Use of magnets is one technique to attach objects on a structure (e.g. the panel system) without using any hand tools. The magnet can also help the householder by attaching/pulling the object on the panel, however, there is a need to ensure a safety of the installed object. If compression force and magnetic field between the installed object and the magnet are insufficient, for example, if the magnet deteriorated and the magnetic field reduced over time, the object may unlock and fall off. Therefore, using the magnet requires a specific system used for facilitating installation of the object thereon and monitoring attaching performance between the object and the magnet, which provide safety to the attached objects and the users. Accordingly, there is a need to develop a magnetic attachment system to integrate with the panel system for safety to the attached objects and the users.

U.S. Pat. No. 9,202,616 B2 disclosed a magnetic system having a plurality of sensors for detecting changes of the magnetic force between two metal structures, in a robotic application, where the magnetic system is used to pick up metal sheets. The magnetic system comprises a structural element, a magnetic structure attached to the structural element by an adhesive, an object formed by ferromagnetic material where the magnetic structure could be magnetically attached to and detached from an object, and a force sensor used to measure the magnetic force between the magnetic structure and the object. Additionally, the system also comprises a hall sensor placed at a predetermined location relative to the magnetic structure to determine any change of the magnetic field. Those sensors provide data to a control system to determine whether the structural element will detach from the object. However, this document fails to teach applying those sensors to be integrated in one unit for verifying the safety of the attached object and the users. Moreover, it does not suggest the use of permanent electromagnet that may be demagnetized from supporting the weight of an object which facilitates adjusting the position of the object.

U.S. Pat. No. 9,619,678 B2 disclosed a Radio-Frequency IDentification (RFID) probe for reading RFID tags in disposable containers. The RFID probe comprises a ring shaped housing having a maximum thickness which is less than the innermost diameter of the housing, a support leg attached to the ring shaped housing, a looped antenna integrated within the ring shaped housing, and an RFID reader module integrated within the ring shaped housing where the RFID reader module is communicably connected to the antenna for transmitting an encoded radio signal to an RFID tag in the container. The container includes the RFID tag having an RF transmitter and an RF receiver. Upon receiving an interrogation signal from the RFID probe, the RFID tag transmits the identification data of the container to the reader. The device according to this disclosure is merely the device for RFID reading and it is silent about integration of RFID with other types of sensors (such as hall sensor and force sensor) for sensing safety of the object. Moreover, it does not suggest the use of permanent electromagnet with the RFID, so as to be a magnetic attachment system for sensing the identity of an object.

With the limit of the disclosure about the magnetic attachment system and aforementioned disadvantages of existing panel systems, the present invention develops a magnetic attachment system having a permanent electromagnet, a sensing unit, and a processor for attaching an object thereon. With the permanent electromagnet working in cooperation with the sensing unit and the processor, this would facilitate users in supporting the weight of the object to be attached thereon. This will help users be able to install objects on panels (such as walls, floors or ceilings) with increased safety. The magnetic attachment system can be applied to either light and/or small objects (e.g. home or office devices) or heavy and/or large objects used in manufacturing facilities or industrial plants (e.g. metal sheets, pipes, industrial equipment, and likes) so that the users can install such objects used with more safety.

### SUMMARY OF THE INVENTION

The present invention develops a magnetic attachment system (100), which facilitates users in supporting the weight of the object to be attached thereon with increased safety. The magnetic attachment system (100) can be applied to either light and/or small objects (e.g. home or office devices) or heavy and/or large objects used in manufacturing facilities or industrial plants (e.g. metal sheets, pipes, industrial equipment, and likes) so that the users can install such objects used with more safety.

The magnetic attachment system (100) according to this invention comprises a permanent electromagnet (200), a sensing unit (300), and a processor for processing the attachment of the object thereon. The processor is configured to perform a method comprising:
i) partially reducing a magnetic field from an initial magnetic field of the permanent electromagnet (200) by applying electrical current thereto;
ii) detecting a pre-stage magnetic field via a magnetic detecting unit (304) and a pre-stage compression force via a compression detecting unit (306), when the user temporarily attaches the object to the permanent electromagnet (200);
iii) terminating applying the electrical current to fully attach the object after receiving to the user's instruction;
wherein step i) the electrical current will be applied in order to reduce the magnetic field of the permanent electromagnet (200) to be able to temporarily attach at least 70% of weight of the object;
wherein step ii) if the pre-stage compression force is not within a predetermined value of the pre-stage compression force, the processor will send a notification to the user.

In another aspect of the invention, the present invention relates to the method for attaching and sensing the object using the magnetic attachment system (100). The method comprises steps of:
i) partially reducing the magnetic field from the initial magnetic field of a permanent electromagnet (200) by applying electrical current thereto;
ii) detecting the pre-stage magnetic field via the magnetic detecting unit (304) and the pre-stage compression force via the compression detecting unit (306), when the user temporarily attaches the object to the permanent electromagnet (200);
iii) terminating applying the electrical current to fully attach the object after receiving to the user's instruction;
wherein step i) the electrical current will be applied in order to reduce the magnetic field of the permanent electromagnet (200) to be allow to temporarily attach at least 70% of the weight of the object;
wherein step ii) if the pre-stage compression force is not within the predetermined value of the pre-stage compression force, the processor will send the notification to the user.

### BRIEF DESCRIPTION OF THE DRAWINGS

For a more complete understanding of the present invention, examples of embodiments, and their advantages, reference is made to the following description taken in conjunction with the accompanying drawings, in which like reference numbers indicate like features. The following figures show perspective views of the example embodiments.

FIG. 1 shows a magnetic attachment system (100) according to the exemplary embodiments of the invention.

FIG. 2 shows a perspective view of a sensing unit (300) according to the exemplary embodiments of the invention.

FIG. 3 shows a top view and a bottom view of the sensing unit (300) according to the exemplary embodiments of the invention.

FIG. 4 shows a flow diagram of method for attaching and sensing an object using the magnetic attachment system (100) according to the exemplary embodiments of the invention.

Although similar reference numbers may be used to refer to similar elements in the figures for convenience, each of the various example embodiments may be considered to be distinct variations.

### DETAILED DESCRIPTION OF THE INVENTION

The present invention relates to a magnetic attachment system and method of use thereof. The magnetic attachment system according to the present invention comprises a permanent electromagnet, a sensing unit and a processor for processing the attachment of an object thereon. With the permanent electromagnet performing in cooperation with the sensing unit and the processor, this would facilitate users in daily routine in supporting the weight of the object to be attached thereon (such as attaching home or office devices to wall panels) with increased safety. Moreover, the magnetic attachment system according to the present invention can also be applied to facilitate users in supporting heavy and/or large objects used in manufacturing facilities or industrial plants (e.g. metal sheets, pipes, industrial equipment, and likes).

Any aspect shown herein is meant to include its application to other aspects of this invention unless stated otherwise.

Technical terms or scientific terms used herein have definitions as known to an ordinary person skilled in the art unless stated otherwise.

Any tools, equipment, methods, or chemicals named herein mean tools, equipment, methods, or chemicals being used commonly by an ordinary person skilled in the art unless expressly stated that they are tools, equipment, methods, or chemicals specific only to this invention.

Use of a singular noun or pronoun with “comprising” in claims or specification means “one” but may also refer to “one or more,” “at least one,” and “one or more than one.”

All components and/or methods disclosed and claims in this application aim to cover embodiments from any action, performance, modification, or adjustment without any experiment that significantly differs from this invention, which would result in creation of an object with the same utility or which would be deemed substantially similar to the present embodiment according to an ordinary person skilled in the art, whether or not such variation is specifically stated in the claims. Therefore, objects that are similar or which may be substitutable for the present embodiment, including those with minor modifications or adjustments that may be clearly devised by an ordinary person skilled in the art should be construed as being within the spirit, scope, and concept of invention as appeared in the appended claims.

Throughout this application, the term “about” means any number referenced herein that could be varied or deviated from any error of equipment, method, or person using said equipment or method.

Example aspects will now be described with reference to the accompanying drawings, which form a part of the present disclosure and which illustrate example embodiments which may be used. As used in the present disclosure and the appended claims, the terms “example embodiment,” “exemplary embodiment,” and “present embodiment” do not necessarily refer to a single embodiment, although they may, and various example embodiments may be readily combined and/or interchanged without departing from the scope or spirit of example embodiments. Furthermore, the terminology as used in the present disclosure and the appended claims are for the purpose of describing example embodiments only, and is not intended to limit interpretation. In this respect, as used in the present disclosure and the appended claims, the term “in” may include “in” and “on,” and the terms “a,” “an,” and “the” may each refer to the singular and plural. Furthermore, as used in the present disclosure and the appended claims, the term “by” may also mean “from,” depending on the context; the term “if” may also mean “when” or “upon,” depending on the context; and the term “and/or” may refer to and encompass any and all possible combinations of one or more of the associated listed items.

The terms, “touch”, “connect”, “connecting”, “connection”, “connected”, “in connection with”, “attach”, “attaching”, “attachment”, “attached”, “install”, “installed”, “installing”, installation” and/or the like may be interchangeably used to refer to or mean direct electronic or physical connection or connection via one or more elements, whether or not power and/or signal are transmitted between such elements, where the connecting parts can be in any type of electrical connector/or physical mechanism.

The term “object” used herein means at least one item or at least one component, including its component parts and/or its accessories, to be attached, directly or indirectly, to the magnetic attachment system, for example decorative material (e.g. tiles, metal plates, wooden plates), decorative accessories (e.g. hanging cabinets, bathroom accessories, kitchen appliances), protective material (e.g. insulation materials, sound-absorbing materials, IoT and/or electronic devices, (e.g. display devices, televisions, touch screen displays, video projectors, audio systems, closed-circuit televisions (CCTV), surveillance cameras, solar cells, solar panels, chargers, water dispensers, air purifiers, lights, light measurement, controllers, air conditioners, fans, kitchen devices, any electrical devices, and the like), mounting accessories (e.g. instrument mounting brackets, hangers, holders, fixtures and jigs), or combination thereof.

The term “temporarily attach”, “temporarily attached”, “temporarily attaching”, “temporarily attachment”, and/or the like used herein means temporarily attaching between the object and the permanent electromagnet, while the magnetic field of the permanent electromagnet (200) is reduced in proportion to the amount of electrical current applied.

The term “fully attach”, “fully attached”, “fully attaching”, “fully attachment”, and/or the like used herein means fully attaching between the object and the permanent electromagnet, while the permanent electromagnet is in fully magnetized stage with no electrical current applied. Although the magnetic field decreases with magnetic degradation over time, if there is no electrical current applied, the permanent electromagnet is still considered as fully attaching the object.

The term “initial magnetic field” means the magnetic field of the permanent electromagnet that is detectable during one or more detection periods, before applying electrical current to the permanent electromagnet in order to partially reduce the magnetic field of the permanent electromagnet. The initial magnetic field is detected when the user starts using the magnetic attachment system (100). The initial magnetic field may be equivalent to the capacity of the permanent electromagnet from the manufacturer.

The term “pre-stage magnetic field” means the magnetic field of the permanent electromagnet that is detectable during one or more detection periods, while the permanent electromagnet is in state of partially reducing the magnetic field from the initial magnetic field in proportion to the amount of electrical current applied.

The term “post-stage magnetic field” means the magnetic field of the permanent electromagnet that is detectable during one or more detection periods, while the permanent electromagnet is in fully magnetized stage with no or insufficient electrical current applied.

The term “pre-stage compression force” means the compression force between the object and the permanent electromagnet, that is detectable during one or more detection periods, while the permanent electromagnet is in state of partially reducing the magnetic field from the initial magnetic field in proportion to the amount of electrical current applied.

The term “post-stage compression force” means the compression force between the object and the permanent electromagnet, that is detectable during one or more detection periods, while the permanent electromagnet is in fully magnetized stage with no or insufficient electrical current applied.

Hereafter, embodiments of the invention are elucidated to show details of the invention by way of explanatory embodiments. The breadth and scope of the present invention should be defined only in accordance with the claims and their equivalents issuing from this disclosure.

In one embodiment of the invention, the present invention relates to a magnetic attachment system (100) comprising:
a permanent electromagnet (200);
a sensing unit (300) configured to sense an object attached on the permanent electromagnet (200), comprising
   at least one magnetic detecting unit (304);
   at least one compression detecting unit (306);
   a processor in communication with the permanent electromagnet (200) and the sensing unit (300);
the processor is configured to perform a method comprising:
   i) partially reducing a magnetic field from an initial magnetic field of the permanent electromagnet (200) by applying electrical current thereto;
   ii) detecting a pre-stage magnetic field via the magnetic detecting unit (304) and a pre-stage compression force via the compression detecting unit (306), when the user temporarily attaches the object to the permanent electromagnet (200);
   iii) terminating applying the electrical current to fully attach the object after receiving to the user's instruction;
wherein step i) the electrical current will be applied in order to reduce the magnetic field of the permanent electromagnet (200) to be able to temporarily attach at least 70% of weight of the object;
wherein step ii) if the pre-stage compression force is not within a predetermined value of the pre-stage compression force, the processor will send a notification to the user.

In another exemplary embodiment, the processor further performs, in step i), detecting magnetic degradation by detecting the initial magnetic field of the permanent electromagnet (200) via the magnetic detecting unit (304), before partially reducing the initial magnetic field.

In another exemplary embodiment, the processor further performs, in step ii), monitoring whether there is a change of pre-stage compression force, and if there is no change for a predetermined period of time, the processor will send the notification to the user whether to fully attach the object.

In another exemplary embodiment, the processor further performs, in step ii), verifying via an identity detecting unit (302) whether the identity of the object is accurate.

In another exemplary embodiment, the processor further performs step v) monitoring magnetic degradation by detecting a post-stage magnetic field of the permanent electromagnet (200) via the magnetic detecting unit (304).

In another exemplary embodiment, if the post-stage magnetic field of the permanent electromagnet (200) is lower than −20% of maximum magnetic field of the permanent electromagnet (200), the processor will send a notification to the user.

In a preferred exemplary embodiment, if the post-stage magnetic field of the permanent electromagnet (200) is lower than −10% of maximum magnetic field of the permanent electromagnet (200), the processor will send a notification to the user.

In another exemplary embodiment, the processor further performs step v) monitoring attaching performance by detecting a post-stage compression force between the object and the permanent electromagnet (200), via the compression detecting unit (306).

In another exemplary embodiment, if the post-stage compression force between the object and the permanent electromagnet (200) is lower than −20% of a predetermined value of the compression force, the processor will send a notification to the user.

In a preferred exemplary embodiment, if the post-stage compression force between the object and the permanent electromagnet (200) is lower than −10% of the predetermined value of the compression force, the processor will send a notification to the user.

In another exemplary embodiment, the processor further performs step v) monitoring compressive strength by detecting the post-stage compression force between the object and the permanent electromagnet (200), via the compression detecting unit (306).

In another exemplary embodiment, if the post-stage compression force between the object and the permanent electromagnet (200) is higher than +20% of a predetermined value of the compression force, the processor will send a notification to the user.

In a preferred exemplary embodiment, if the post-stage compression force between the object and the permanent electromagnet (200) is higher than +10% of the predetermined value of the compression force, the processor will send a notification to the user.

In another exemplary embodiment, the predetermined value of the compression force is an initial value of post-stage compression force when the object is fully attached on the permanent electromagnet (200).

In another exemplary embodiment, the processor further performs, in step v), detecting environmental factors by using an environmental-detecting unit.

In another aspect of the invention, the present invention relates to a method for attaching and sensing an object using a magnetic attachment system (100), comprising steps of:
i) partially reducing a magnetic field from an initial magnetic field of a permanent electromagnet (200) by applying electrical current thereto;
ii) detecting the pre-stage magnetic field via a magnetic detecting unit (304) and the pre-stage compression force via a compression detecting unit (306), when the user temporarily attaches an object to the permanent electromagnet (200);
iii) terminating applying the electrical current to fully attach the object after receiving to the user's instruction;
wherein step i) the electrical current will be applied in order to reduce the magnetic field of the permanent electromagnet (200) to be allow to temporarily attach at least 70% of the weight of the object;
wherein step ii) if the pre-stage compression force is not within a predetermined value of the pre-stage compression force, a processor will send a notification to the user.

In another exemplary embodiment, the step i) further comprises a step of detecting magnetic degradation by detecting the initial magnetic field of the permanent electromagnet (200) via the magnetic detecting unit (304), before partially reducing the initial magnetic field.

In another exemplary embodiment, the step ii) further comprises a step of monitoring whether there is a change of pre-stage compression force, and if there is no change for a predetermined period of time, the processor will send a notification to the user whether to fully attach the object.

In another exemplary embodiment, the step ii) further comprises a step of verifying via an identity detecting unit (302) whether the identity of the object is accurate.

In another exemplary embodiment, the method further comprises step v) monitoring magnetic degradation by detecting a post-stage magnetic field of the permanent electromagnet (200) via the magnetic detecting unit (304).

In another exemplary embodiment, if the post-stage magnetic field of the permanent electromagnet (200) is lower than −20% of maximum magnetic field of the permanent electromagnet (200), the processor will send a notification to the user.

In a preferred exemplary embodiment, if the post-stage magnetic field of the permanent electromagnet (200) is lower than −10% of maximum magnetic field of the permanent electromagnet (200), the processor will send a notification to the user.

In another exemplary embodiment, the method further comprises step v) monitoring attaching performance by detecting a post-stage compression force between the object and the permanent electromagnet (200), via the compression detecting unit (306).

In another exemplary embodiment, if the post-stage compression force between the object and the permanent electromagnet (200) is lower than −20% of a predetermined value of the compression force, the processor will send a notification to the user.

In a preferred exemplary embodiment, if the post-stage compression force between the object and the permanent electromagnet (200) is lower than −10% of the predetermined value of the compression force, the processor will send a notification to the user.

In another exemplary embodiment, the method further comprises step v) monitoring compressive strength by detecting the post-stage compression force between the object and the permanent electromagnet (200), via the compression detecting unit (306).

In another exemplary embodiment, if the post-stage compression force between the object and the permanent electromagnet (200) is higher than +20% of a predetermined value of the compression force, the processor will send a notification to the user.

In a preferred exemplary embodiment, if the post-stage compression force between the object and the permanent electromagnet (200) is higher than +10% of the predetermined value of the compression force, the processor will send a notification to the user.

In another exemplary embodiment, the predetermined value of the compression force is an initial value of post-stage compression force when the object is fully attached on the permanent electromagnet (200).

In another exemplary embodiment, the step v) further comprises a step of detecting environmental factors by using an environmental-detecting unit.

It should be understood that examples of the invention described hereinafter have been presented by way of explanatory and exemplary embodiments of the present invention only. Thus, the breadth and scope of the present invention should be defined only in accordance with the claims and their equivalents issuing from this disclosure.

### Example Embodiments

These example embodiments of the invention will now be described below with reference to the accompanying drawings, which form a part of the present disclosure.

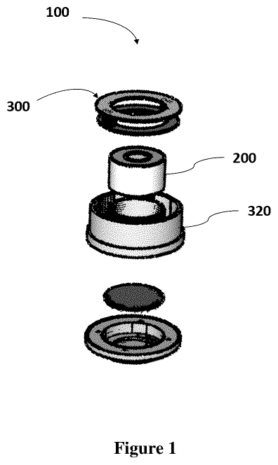

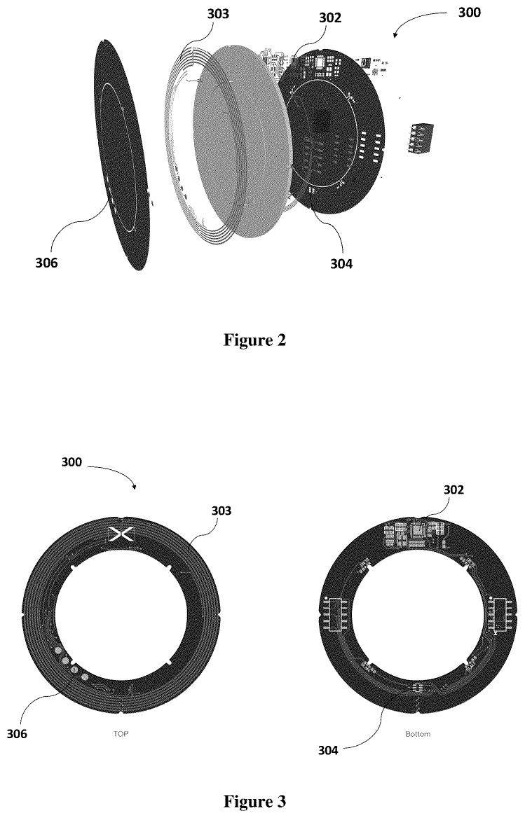

According to FIG. 1 and FIG. 2, a magnetic attachment system (100) of the exemplary embodiments of the invention comprises a permanent electromagnet (200) configured to fully magnetize when there is no electrical current applied, and a sensing unit (300) configured to sense the object attached on the permanent electromagnet (200). The sensing unit (300) comprises at least one identity detecting unit (302) for detecting the identity of the object, at least one magnetic detecting unit (304) for detecting a magnetic field, and at least one compression detecting unit (306) for detecting a compression force. The magnetic attachment system (100) also comprises a processor in communication with the permanent electromagnet (200), the identity detecting unit (302), the magnetic detecting unit (304), and the compression detecting unit (306), which will be described in detail later.

The permanent electromagnet (200) is a type of magnet that is always in a state of fully magnetized when there is no electrical current applied. However, when a user partially applies the electrical current to the permanent electromagnet (200), it would partially reduce the amount of magnetic field. With this characteristic of permanent electromagnet (200), it can be used to temporarily attach the object or temporarily hold the object while installing the object on the permanent electromagnet (200). While temporarily attaching the object, the permanent electromagnet (200) supports partial weight of the object for a period, where the user can conveniently adjust the object by rotating or moving the object with less force. After the user adjusts the position of the object, the user may stop applying the electrical current to let the permanent electromagnet (200) be fully magnetized for fully attaching the object.

The permanent electromagnet (200) may be configured to receive input of user's instructions in order to reduce the magnetic field. For example, the user may input the instruction allowing the permanent electromagnet (200) to be able to temporarily attach at least 70% of the weight of the object, where the processor may automatically determine the amount of electrical current applied to the permanent electromagnet (200) by calculation based on a size of magnet and weight of the object. The permanent electromagnets (200) may be designed to have holding capacity of 5 to 100 kg for attaching objects. The permanent electromagnet (200) can also be applied to facilitate the user in supporting heavy and/or large objects used in manufacturing facilities or industrial plants (e.g. metal sheets, pipes, industrial equipment, and likes). The permanent electromagnet (200) may be designed to have a holding capacity of up to 15,000 kg depending on the object, without any purpose to limit any scope of the invention.

The sensing unit (300) may be covering with a housing (320). The housing (320) may be formed in a geometric shape selected from a ring, triangle, circle, trapezoid, hexagon and the like. The housing (320) may be a rigid casing that protects the identity detecting unit (302), the magnetic detecting unit (304), the compression detecting unit (306) and the processor from damage. The sensing unit (300) according to the example embodiment may be designed in a ring shape housing (320) with a thickness in the range of 5 to 30 mm and a diameter in the range of 20 to 100 mm.

As shown in FIG. 2 and FIG. 3, the identity detecting unit (302) of the sensing unit (300) is disposed inside the sensing unit (300) for detecting the identity of the object and transmitting such identity to the processor. The identity is basic information of the object including designed position, trade name, size, type, model, weight, delivery tracking, production date and the likes. The basic information indicates the identity of the object when the user buys and/or sells said object. The user can ensure that the object is exactly as its design or it is a genuine object certified by a manufacturer. For example, the identity detecting unit (302) may comprise a Radio-Frequency IDentification (RFID) unit with RFID antenna (303) for receiving the identity of an RFID tag inside the object. After the identity detecting unit (302) detects the identity of the object, the processor, connected to the identity detecting unit (302), verifies an identification result by comparing the identity of the object with an identity data. The identity is verified in terms of true (accurate) or false (inaccurate) condition. If the identification result is false, the processor will send a notification to the user to check the object. The identity data is the data (for example: product name, product model, production date, expiration date, batch number, lot number, size, dimension, weight, color, material, or combination thereof) generated by the manufacturer where the object was made. This may be collected into a cloud system for an online platform. The processor can be designed to connect and retrieve the identity data as an online mode and/or offline mode.

The magnetic detecting unit (304), disposed on the bottom side of the sensing unit (300), is configured to detect the magnetic field between the permanent electromagnet (200) and the object. The magnetic detecting unit (304) detects an initial magnetic field when performing the magnetic attachment system (100). While the user partially reduces a magnetic field from the initial magnetic field of the permanent electromagnet (200) for temporarily attaching the object, the magnetic detecting unit (304) will detect the magnetic field in terms of a pre-stage magnetic field. The user can move the object easily without having to exert a lot of force, because the permanent electromagnet (200) partially supports weight of the object (for example, supports at least 70% of weight of the object). After that, if the user terminates applying the electrical current to the permanent electromagnet (200) such that the object is fully attached to the permanent electromagnet (200), the magnetic detecting unit (304) will detect a post-stage magnetic field for monitoring magnetic degradation of the permanent electromagnet (200). If the post-stage magnetic field of the permanent electromagnet (200) is lower than −20% of maximum magnetic field of the permanent electromagnet (200), preferably −10% of maximum magnetic field, the processor will send the notification to the user that the permanent electromagnet (200) is degraded and may need to be replaced.

The magnetic detecting unit (304) may be a sensor for detecting the magnetic field such as hall sensor. The hall sensor may be designed to detect the magnetic field in the range of 2,000 to 10,000 gauss (G). However, the magnetic detecting unit (304) may be adjusted for the range of detecting the magnetic field depending on the capacity of permanent electromagnet (200) and the weight of object.

The compression detecting unit (306), disposed on the top side of the sensing unit (300), is configured to detect the compression force exerted between the permanent electromagnet (200) and the object. The compression detecting unit (306) detects the compression force in term of a pre-stage compression force when the user temporarily attaches the object to the permanent electromagnet (200). The user can move the object easily without having to exert a lot of force because the partial weight of the object is supported by magnetic field from the permanent electromagnet (200). However, if the pre-stage compression force is not within a predetermined value of the pre-stage compression force, the processor will send the notification to the user. The pre-stage compression force may not be within a predetermined value if the object is attached incorrectly (such as wrong position, wrong alignment and/or inaccurate angle) or there is an interference between the object and the permanent electromagnet (200) (such as plastic sheet as barrier). The predetermined value of the pre-stage compression force may be determined based on weight of the object, shape of the object, an angle between the object and the permanent electromagnet (200), vertical or horizontal installation of the object, or combination thereof. Moreover, the processor may monitor whether there is a change of pre-stage compression force, and if there is no change for a predetermined period of time, the processor will send the notification to the user whether to fully attach the object.

When the user instructs the system to terminate applying the electrical current to the permanent electromagnet (200) such that the object is fully attached to the permanent electromagnet (200), the compression detecting unit (306) will detect the post-stage compression force for monitoring attaching performance and monitoring compressive strength on the object. In the case of the attaching performance, if the post-stage compression force between the object and the permanent electromagnet (200) is lower than −20% of predetermined value of the compression force, preferably −10% of predetermined value of the compression force, the processor will send the notification to the user that the attaching performance is less and the object may fall-off. On the other hand, in the case of the compressive strength, if the post-stage compression force between the object and the permanent electromagnet (200) is higher than +20% of predetermined value of the compression force, preferably +10% of predetermined value of the compression force, the processor will send the notification to the user that the object is under high compression which may damage to the object. The predetermined value of the compression force may be an initial value of post-stage compression force when the object is fully attached on the permanent electromagnet (200). In some case, the predetermined value of the compression force may be determined from the manufacturer, where it is calculated based on weight of the object, shape of the object, an angle between the object and the permanent electromagnet (200), vertical or horizontal installation of the object.

The compression detecting unit (306) may be a sensor for detecting the compression force, such as force sensor or strain gauge. The force sensor may be designed to detect the compression force in the range of 20 to 1,000 newton (N). However, the compression detecting unit (306) may be adjusted for the range of detecting the compression force depending on the capacity of permanent electromagnet (200) and the weight of object.

The sensing unit (300) further comprises a connecting unit (not shown here) located on one side of the sensing unit (300) for electrical connection between the sensing unit (300) and the object. This may provide data communication, power supply, or internet connection to the object. In addition, the sensing unit (300) can be further integrated with at least one environmental-detecting unit for measuring environmental factors within a space (e.g. temperature, pressure, humidity). The environmental-detecting unit may comprise at least one environmental-detecting sensor selected from temperature sensor, pressure sensor, humidity sensor, vibration sensor, flame sensor, smoke sensor and the like for detecting or measuring other physical properties within the space according to user needs.

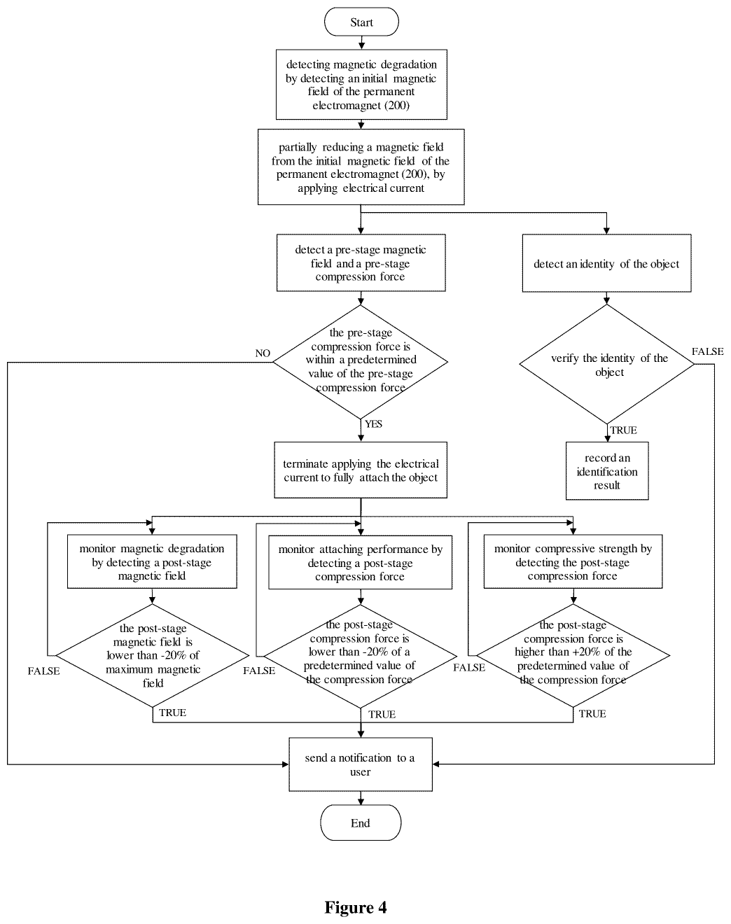

FIG. 4 shows a flow diagram of a method for attaching and sensing an object using the magnetic attachment system (100) according to the exemplary embodiments of the invention. The method comprises the steps of:
a) detecting magnetic degradation by detecting an initial magnetic field of the permanent electromagnet (200) via a magnetic detecting unit (304) and notifying the user by the processor, if there is any degradation of the permanent electromagnet (200), before performing to partially reduce a magnetic field;
b) partially reducing the magnetic field from the initial magnetic field of the permanent electromagnet (200) by applying electrical current thereto. The electrical current may be applied in order to reduce the magnetic field of the permanent electromagnet (200) to be able to temporarily attach at least 70% of the weight of the object;
c) detecting a pre-stage magnetic field via the magnetic detecting unit (304), detecting a pre-stage compression force via the compression detecting unit (306), and detecting the identity via the identity detecting unit (302), when the user temporarily attaches the object to the permanent electromagnet (200);
   in case of the identity, the processor verifies an identification result by comparing the identity of the object with an identity data:
      if the identification result is false, the processor will send a notification to the user;
      if the identification result if true the processor will record the identification result to update the identity data;
   in the case of the pre-stage compression force, the processor monitors if the pre-stage compression force is not within predetermined value of the pre-stage compression force, and the processor will send the notification to the user. Moreover, the processor also monitors whether there is a change of pre-stage compression force, and if there is no change for a predetermined period of time, the processor will send the notification to the user whether to fully attach the object; and
d) terminating applying the electrical current to fully attach the object after receiving the user's instruction. When the user inputs the instruction to the processor for terminating the electrical current, the object will be attached stably on the permanent electromagnet (200) which is fully magnetized. Then, the processor will verify the safety between the object and the permanent electromagnet (200) by:
   monitoring magnetic degradation by detecting a post-stage magnetic field, and if the post-stage magnetic field is lower than −20% of maximum magnetic field, the processor will send the notification to the user that the permanent electromagnet (200) is degraded and may need to be replaced;
   monitoring attaching performance by detecting a post-stage compression force, and if the post-stage compression force is lower than −20% of a predetermined value of the compression force, the processor will send the notification to the user that the attaching performance is less and the object may fall-off; and
   monitoring compressive strength by detecting the post-stage compression force, and if the post-stage compression force is higher than +20% of the predetermined value of the compression force, the processor will send the notification to the user that the object is under high compression which may damage the object.

One advantage of the magnetic attachment system (100) among others is that it can also detect and monitor the force acting on the object. For example, in the facility, if the magnetic attachment system (100) is installed on the floor which is equipped with pipes (regarded as object), and if there is force applied to the pipes, such as from people walking or instruments overlaying thereon, the post-stage compression force would be higher. The compression detecting unit (306) will detect the post-stage compression force that is increased, and then transmit it to the processor in order to notify to workers to check whether there is any damage to the pipes. This provides more safety and security to the facility.

If required, the user can use plurality of the magnetic attachment systems (100) in combination for preferably attaching large or heavy objects. Said plurality of the magnetic attachment systems (100) may be assembled to simultaneously contribute the magnetic field and the compression force to the assembled system. In this case, these magnetic attachment systems (100) can be configured to either work integrately as one system or work separately.

All the examples of the magnetic attachment system (100) can be applied in any structure for constructing walls, partitions, ceilings and floors for houses, offices, conference rooms, education places, gaming or entertainment rooms, VR rooms, hologram rooms, hospitals, operating rooms, robotic rooms, testing/experiment rooms, containers, manufacturing facilities or industrial plants, any kind of building, or any type of construction involving walls, ceilings and floors, without any purpose to limit any scope of the invention.

The material of any components of the magnetic attachment system (100) can be adjusted/modified to suit the environment and atmosphere in that area, whether it is used in a normal atmosphere, under the sea level where materials resistant to corrosion are required, or in the case of use in outer space (extremely high vacuum) where lightweight and very strong materials are required. While the property of the material may be changed, and is expected by an ordinary person skilled in the art, the components and functions would not differ from the scope of the present invention.

While an embodiment of the invention has been illustrated and described, it is appreciated that various changes can be made therein without departing from the spirit and scope of the invention.

While various embodiments in accordance with the disclosed principles have been described above, it should be understood that they have been presented by way of example only, and are not limiting. Thus, the breadth and scope of the example embodiments described in the present disclosure should not be limited by any of the above-described exemplary embodiments, but should be defined only in accordance with the claims and their equivalents issuing from this disclosure. Furthermore, the above advantages and features provided in the described embodiments shall not limit the application of such issued claims to processes and structures accomplishing any or all of the above advantages.

### Best Mode or Preferred Embodiment of the Invention

Best mode or preferred embodiment of the invention is as provided in the description of the invention.

1. A magnetic attachment system (100) comprising:
a permanent electromagnet (200);
a sensing unit (300) configured to sense an object attached on the permanent electromagnet (200), comprising
at least one magnetic detecting unit (304);
at least one compression detecting unit (306);
a processor in communication with the permanent electromagnet (200) and the sensing unit (300);
the processor is configured to perform a method comprising:
i) partially reducing a magnetic field from an initial magnetic field of the permanent electromagnet (200) by applying electrical current thereto;
ii) detecting a pre-stage magnetic field via the magnetic detecting unit (304) and a pre-stage compression force via the compression detecting unit (306), when the user temporarily attaches the object to the permanent electromagnet (200);
iii) terminating applying the electrical current to fully attach the object after receiving to the user's instruction;
wherein step i) the electrical current will be applied in order to reduce the magnetic field of the permanent electromagnet (200) to be able to temporarily attach at least 70% of weight of the object;
wherein step ii) if the pre-stage compression force is not within a predetermined value of the pre-stage compression force, the processor will send a notification to the user.

2. The magnetic attachment system (100) according to claim 1, wherein the processor further performs, in step i), detecting magnetic degradation by detecting the initial magnetic field of the permanent electromagnet (200) via the magnetic detecting unit (304), before partially reducing the initial magnetic field.

3. The magnetic attachment system (100) according to claim 1, wherein the processor further performs, in step ii), monitoring whether there is a change of pre-stage compression force, and if there is no change for a predetermined period of time, the processor will send the notification to the user whether to fully attach the object.

4. The magnetic attachment system (100) according to claim 1, wherein the processor further performs, in step ii), verifying via an identity detecting unit (302) whether the identity of the object is accurate.

5. The magnetic attachment system (100) according to claim 1, wherein the processor further performs step v) monitoring magnetic degradation by detecting a post-stage magnetic field of the permanent electromagnet (200) via the magnetic detecting unit (304).

6. The magnetic attachment system (100) according to claim 5, wherein if the post-stage magnetic field of the permanent electromagnet (200) is lower than −20% of maximum magnetic field of the permanent electromagnet (200), the processor will send a notification to the user.

7. The magnetic attachment system (100) according to claim 6, wherein if the post-stage magnetic field of the permanent electromagnet (200) is lower than −10% of maximum magnetic field of the permanent electromagnet (200), the processor will send a notification to the user.

8. The magnetic attachment system (100) according to claim 1, wherein the processor further performs step v) monitoring attaching performance by detecting a post-stage compression force between the object and the permanent electromagnet (200), via the compression detecting unit (306).

9. The magnetic attachment system (100) according to claim 8, wherein if the post-stage compression force between the object and the permanent electromagnet (200) is lower than −20% of a predetermined value of the compression force, the processor will send a notification to the user.

10. The magnetic attachment system (100) according to claim 9, wherein if the post-stage compression force between the object and the permanent electromagnet (200) is lower than −10% of the predetermined value of the compression force, the processor will send a notification to the user.

11. The magnetic attachment system (100) according to claim 1, wherein the processor further performs step v) monitoring compressive strength by detecting the post-stage compression force between the object and the permanent electromagnet (200), via the compression detecting unit (306).

12. The magnetic attachment system (100) according to claim 11, wherein if the post-stage compression force between the object and the permanent electromagnet (200) is higher than +20% of a predetermined value of the compression force, the processor will send a notification to the user.

13. The magnetic attachment system (100) according to claim 12, wherein if the post-stage compression force between the object and the permanent electromagnet (200) is higher than +10% of the predetermined value of the compression force, the processor will send a notification to the user.

14. The magnetic attachment system (100) according to claim 8, wherein the predetermined value of the compression force is an initial value of post-stage compression force when the object is fully attached on the permanent electromagnet (200).

15. The magnetic attachment system (100) according to claim 5, wherein the processor further performs, in step v), detecting environmental factors by using an environmental-detecting unit.

16. A method for attaching and sensing an object using a magnetic attachment system (100), comprising steps of:
i) partially reducing a magnetic field from an initial magnetic field of a permanent electromagnet (200) by applying electrical current thereto;
ii) detecting the pre-stage magnetic field via a magnetic detecting unit (304) and the pre-stage compression force via a compression detecting unit (306), when the user temporarily attaches an object to the permanent electromagnet (200);
iii) terminating applying the electrical current to fully attach the object after receiving to the user's instruction;
wherein step i) the electrical current will be applied in order to reduce the magnetic field of the permanent electromagnet (200) to be allow to temporarily attach at least 70% of the weight of the object;
wherein step ii) if the pre-stage compression force is not within a predetermined value of the pre-stage compression force, a processor will send a notification to the user.

17. The method according to claim 16, wherein the step i) further comprises a step of detecting magnetic degradation by detecting the initial magnetic field of the permanent electromagnet (200) via the magnetic detecting unit (304), before partially reducing the initial magnetic field.

18. The method according to claim 16, wherein the step ii) further comprises a step of monitoring whether there is a change of pre-stage compression force, and if there is no change for a predetermined period of time, the processor will send a notification to the user whether to fully attach the object.

19. The method according to claim 16, wherein the step ii) further comprises a step of verifying via an identity detecting unit (302) whether the identity of the object is accurate.

20. The method according to claim 16, wherein the method further comprises step v) monitoring magnetic degradation by detecting a post-stage magnetic field of the permanent electromagnet (200) via the magnetic detecting unit (304).

21. The method according to claim 20, wherein if the post-stage magnetic field of the permanent electromagnet (200) is lower than −20% of maximum magnetic field of the permanent electromagnet (200), the processor will send a notification to the user.

22. The method according to claim 21, wherein if the post-stage magnetic field of the permanent electromagnet (200) is lower than −10% of maximum magnetic field of the permanent electromagnet (200), the processor will send a notification to the user.

23. The method according to claim 16, wherein the method further comprises step v) monitoring attaching performance by detecting a post-stage compression force between the object and the permanent electromagnet (200), via the compression detecting unit (306).

24. The method according to claim 23, wherein if the post-stage compression force between the object and the permanent electromagnet (200) is lower than −20% of a predetermined value of the compression force, the processor will send a notification to the user.

25. The method according to claim 24, wherein if the post-stage compression force between the object and the permanent electromagnet (200) is lower than −10% of the predetermined value of the compression force, the processor will send a notification to the user.

26. The method according to claim 16, wherein the method further comprises step v) monitoring compressive strength by detecting the post-stage compression force between the object and the permanent electromagnet (200), via the compression detecting unit (306).

27. The method according to claim 26, wherein if the post-stage compression force between the object and the permanent electromagnet (200) is higher than +20% of a predetermined value of the compression force, the processor will send a notification to the user.

28. The method according to claim 27, wherein if the post-stage compression force between the object and the permanent electromagnet (200) is higher than +10% of the predetermined value of the compression force, the processor will send a notification to the user.

29. The method according to claim 23, wherein the predetermined value of the compression force is an initial value of post-stage compression force when the object is fully attached on the permanent electromagnet (200).

30. The method according to claim 20, wherein the step v) further comprises a step of detecting environmental factors by using an environmental-detecting unit.
